(19) United States
(12) Patent Application Publication
(10) Pub. No.: US 2022/0321740 A1
(43) Pub. Date: Oct. 6, 2022

(54) SPOT COLOR EMULATION

(71) Applicant: Hewlett-Packard Development Company, L.P., Spring, TX (US)

(72) Inventors: Dan BEN-YAAKOV, Nes Ziona (IL); Ran Waidman, Nes Ziona (IL); Nir Guttman, Nes Ziona (IL)

(73) Assignee: Hewlett-Packard Development Company, L.P., Spring, TX (US)

(21) Appl. No.: 17/634,143

(22) PCT Filed: Oct. 25, 2019
(86) PCT No.: PCT/US2019/058086

§ 371 Date: Feb. 9, 2022

(51) Int. Cl. H04N 1/60; G06K 15/02

(52) U.S. Cl. CPC H04N 1/6027; H04N 1/603; G06K 15/1878; G06K 15/1836

(57) ABSTRACT

In an example, a method comprises: receiving, at a raster image processor, image data representing a print job, the image data representing an area to be printed using a process color separation and an area to be printed using a spot color; producing at the raster image processor, a first rasterized image representing a layer of the print job having the process color and a second rasterized image representing a layer of the print job having the spot color; receiving at an emulator, the second rasterized image; and representing, by the emulator, the second rasterized image as a plurality of constituent process color separation layers.

### BACKGROUND

Printing apparatuses may print images using a set of process colors, i.e. a basic set of colored print agents (such as Cyan, Magenta, Yellow and Key (Black) (CMYK), or Red, Green and Blue (RGB)). The process colors may be effectively combined using printing techniques such as halftoning to produce colors other than the basic set. In some cases, where a specific color is to be printed with a high level of color accuracy (for example for printing a particular brand color, e.g. for packaging and labels), that color may be defined as a spot color. In order to reproduce the spot color accurately, a print agent may be produced to have the particular spot color which is then printed directly onto a print media rather than forming that color on the print media from the process colors. In some print apparatuses, the spot color may be emulated using the process colors.

### BRIEF DESCRIPTION OF THE DRAWINGS

Non-limiting examples will now be described with reference to the accompanying drawings, in which:

FIG. 1 shows a schematic representation of an example method, which may be a method of emulating a spot color;

FIG. 2 shows a schematic representation of another example method, which may be a method of emulating a spot color;

FIG. 3 shows a schematic representation of an example printing apparatus;

FIG. 4 shows a schematic representation of another example printing apparatus;

FIG. 5 shows a schematic representation of an example machine-readable medium in association with a processor;

FIG. 6 shows a schematic representation of another example machine-readable medium in association with a processor.

### DETAILED DESCRIPTION

Users of a printing system often request a higher level of accuracy for spot colors (which may be for example, a brand color or a color of a logo) than for other parts of an image. When spot colors are emulated using process colors, the spot colors may be treated similarly to other colors in the image. For example, all of the colors in the image may be represented as a set of process colors which are then passed to a printer for printing. The printer may therefore receive image data for an image to be printed as a set of images each representing a different process color. Information specifically associated with the spot colors (such as where they are located on the page and color value information) may therefore be lost to the printer. Any corrections or calibrations that may be applied at the printer to the received set of process color images will therefore not take into account spot color specific information. This can make it difficult to maintain the level of color accuracy requested by users of a printing system for spot color areas of the image. The examples described herein may provide a method of representing spot colors using process colors while maintaining accurate representation of the spot colors.

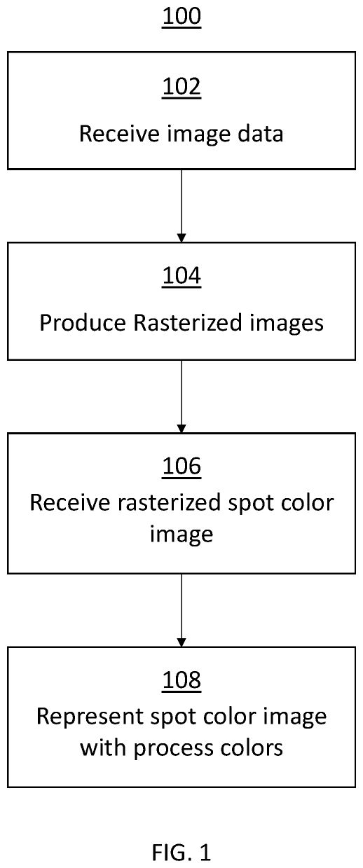

FIG. 1 shows a method 100, which may be a method for emulating spot colors, comprising, at block 102, receiving at a raster image processor, image data representing a print job, the image data representing an area to be printed using a process color separation and an area to be printed using a spot color. In some examples, block 102 may comprise receiving image data comprising an area or areas to be printed in standard colors with a relatively lower level of color accuracy, and an area or areas to be printed in spot colors, with a relatively higher level of color accuracy. The standard colors may be printed using a process color separation or a plurality of process color separations, combined using printing techniques such as halftoning to produce each standard color. The image data for the area to be printed using a process color separation, or a plurality of process color separations, therefore represents a standard color, which may be to be printed with a relatively lower level of color accuracy. The raster image processor (RIP) may be part of a printing apparatus, for example the RIP may be part of a digital front end (DFE) of a printer. The image data received by the RIP may be, e.g. a PDF (portable document format) file, or other suitable image file.

Block 104 of the method 100 comprises producing, at the raster image processor, a first rasterized image representing a layer of the print job having the process color and a second rasterized image representing a layer of the print job having the spot color. Block 104 may comprise separating the image data into data representing standard color areas and data representing spot color areas. The data representing standard color areas may then be represented as a plurality of process color layers, while the spot color areas are represented as a separate spot color layer, for each spot color.

Keeping the second rasterized image (representing the spot color) separate from rasterized images representing any process color layers that make up the standard colors enables keeping track of the spot color areas of the image past the RIP stage. This enables the color accuracy of the spot colors to be tracked and calibrated separately from the standard colors during printing, and enables the spot colors to be represented with higher color accuracy. This system can also enable print jobs to be smoothly transferred between analog printing systems (which include a specific print agent to print the requested spot colors) and digital printing systems (that emulate the spot colors from process colors), while maintaining quality and color accuracy of the spot colors.

Block 106 of the method 100 comprises receiving, at an emulator, the second rasterized image. In some examples, the emulator may be part of the computer of a press of a printing apparatus.

Block 108 of the method 100 comprises representing, by the emulator, the second rasterized image as a plurality of constituent process color separation layers.

In this way, the process color separation layers that are used to form the spot colors of the print job are formed separately from the process color separation layers that are used to make up the standard colors. Therefore, corrections or calibrations can be applied specifically to the emulated spot colors e.g. by adjusting the spot color layer, by adjusting the constituent process color separation layers, or by adjusting an emulation process that converts the spot color layer into its constituent layers (e.g. by adjusting a LUT used by the emulator). The spot colors can also be tracked throughout the printing process, as the information relating to whereabouts in the print job the spot colors are located is not lost at the RIP stage.

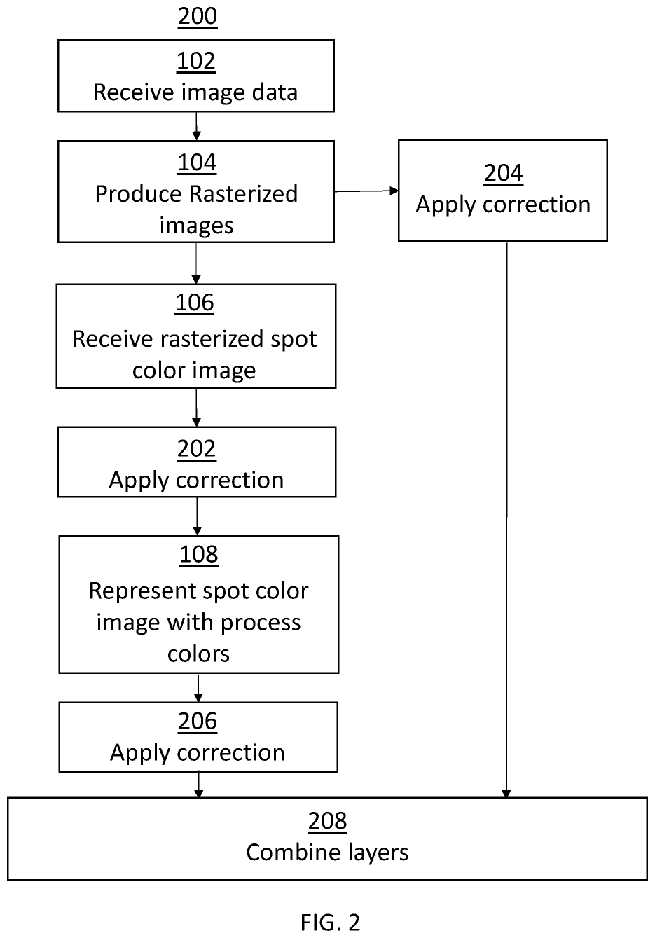

FIG. 2 shows another method 200 of emulating spot colors for printing. The method 200 includes blocks 102 to 108 as described above in relation to FIG. 1.

In some examples, corrections may be applied to the second rasterized image (the spot color image) at block 202 of method 200. For example, the emulator may be controlled to emulate the spot color differently (for example using different amounts of each of the process colors) e.g. in different areas of the image, to correct for location dependent inaccuracies. The emulator may include an LUT to convert the spot color into a set of process colors and some examples may include applying corrections to the emulator LUT, e.g. based on on-the-fly monitoring of jobs as they are printed. In some examples, a continuous color correction may be applied to the second rasterized image prior to or via conversion of the second rasterized image into process color separations. For example, this may be applied by applying corrections to the emulator LUT. This may enable page to page corrections to be applied to the spot color areas. This also helps to ensure that the spot colors are represented accurately in the job as printed. For example, corrections may correct for effects such as halftone screening effects, registration effects, multi-ink interaction effects etc.

Therefore, corrections can be applied separately to the set of process color separations that are to represent the spot color and to the set of process color separations that are to represent the standard colors. This enables the spot colors to be reproduced with a high level of accuracy while efficiently using processing resources, as stricter and more processing intensive corrections can be applied to the spot colors. For example, the spot color areas can be tracked, measured and corrected using iterative correction techniques (explained in more detail below).

In addition, method 200 may comprise comprising performing a first set of corrections on the first rasterized image at block 204 and performing a second set of corrections on the plurality of constituent process color separation layers at block 206.

For example, the first set of corrections may include a job correction which may comprise applying printer-specific corrections to control the tonality of the process colors and may comprise applying location dependent corrections (e.g. dependent on a printing location on a print media). The first set of corrections may include applying a continuous color correction to compensate for page to page color variations. The first set of corrections may include a D-dimensional (where D stands for the number of process inks) color calibration correction which may correct for color variation effects caused by interactions between different colors (e.g. halftoning, screening effects etc). The first set of corrections may include applying a linearization correction, i.e. applying curves to compensate for grey level effects e.g. due to drop spreading which may cause differences in the expected grey level of the printed image compared with the image data. Each of the first set of corrections may comprise using a look-up-table (LUT) to apply modifications to the image data for the job. The second set of corrections may include, for example, applying a job correction and a linearization correction. In some examples, the second set of corrections may include any of the first set of corrections. In some examples, one or more of the second set of corrections may use different LUT's compared with the first set of corrections.

Furthermore, method 200 comprises combining the process color separation layers of the plurality of constituent process color separation layers with the first rasterized image, or images, from which the standard colors are to be formed. Therefore, for an example print job that includes one spot color, along with a plurality of standard colors, at block 208 the two sets of process color separation layers (one set to make up the spot color and the other set to make up the standard colors) are combined into a single set of process color separations for printing. In some examples, the method may also comprise printing the combined process color separations. In some examples, the method 200 may comprise combining the two sets of color separation layers after a different correction or corrections have been applied to each set. This enables spot color specific corrections to be applied to the constituent process color separation layers that are to make up the spot color.

In some examples, corrections may be applied to the combined color separations before printing, for example a linearization correction (as described above) may be applied to the combined color separations rather than being applied separately to each set of color separations.

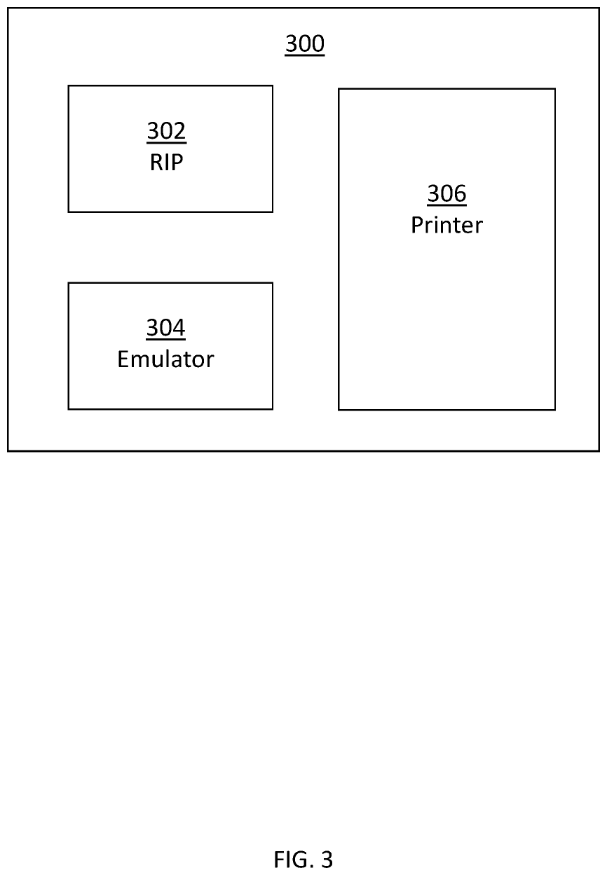

FIG. 3 shows an example printing apparatus 300, which may be a digital printing apparatus, and which may be to perform the method 100 of FIG. 1 and/or the method 200 of FIG. 2. The printing apparatus 300 comprises a raster image processor 302 to convert an image file representing a print job into a plurality of rasterized images wherein a first set of the plurality of rasterized images each represent a color separation of the printing apparatus 300 and wherein a second set of the rasterized images each represent a spot color to be formed from a plurality of the color separations of the printing apparatus 300. The apparatus 300 also comprises an emulator 304, wherein the emulator 304 is to: convert each rasterized image of the second set into a third set of rasterized images each representing a color separation of the printing apparatus 300. The printing apparatus 300 also comprises a printer 306 to print the print job using the set of color separations as defined by the first and third sets of rasterized images. The printer may comprise, for example, an electrophotographic printer, an inkjet printer or other suitable printer.

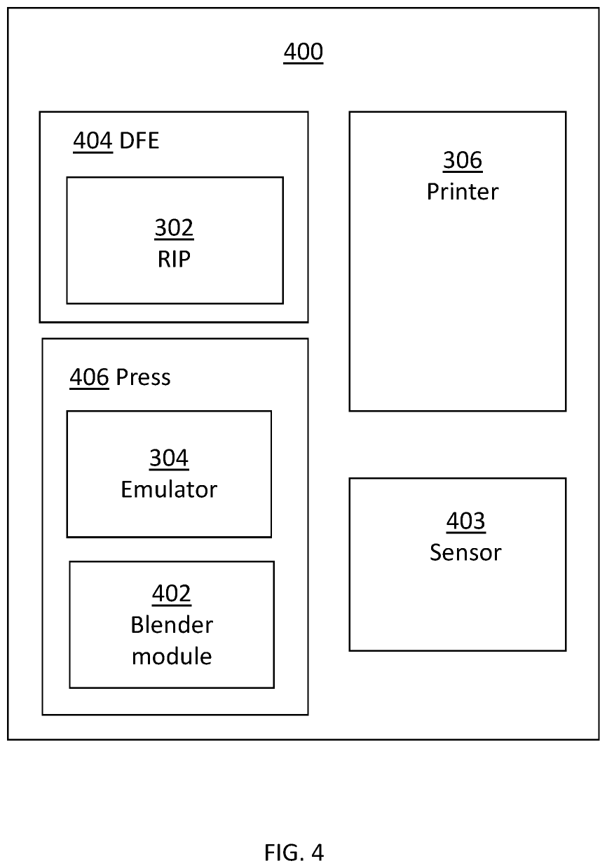

FIG. 4 shows another example printing apparatus 400. Printing apparatus 400 includes an RIP 302, an emulator 304 and a printer 306 as described above in relation to FIG. 3. Printing apparatus 400, may also comprise a blender module 402 to combine the first set of rasterized images with the third set of rasterized images to form a fourth set of rasterized images, each representing a color separation of the printing apparatus 400. For example, a cyan layer rasterized image of the first set may be added to a cyan layer rasterized image of the third set to form a single cyan layer to be sent to the printer, and this process may be repeated for each color separation of the printer (e.g. CMYK). The blender module 402 therefore produces a single set of color separation layers to be sent to printer 306 for printing.

In some examples, the blender module 402 may be to, for an overlap area of the print job representing an overlap between a spot color and a second color, simulate overprinting between the spot color and the second color to provide simulated color data, and determine intended color data for the overlap area in the fourth set of rasterized images based on the simulated color data. In this way, overprinting of the spot color with other colors can be emulated more accurately.

In some examples, the apparatus may be to track areas of the print job that comprise a spot color, based on the second set of rasterized images. Therefore, the spot color areas can be treated differently and/or monitored throughout the printing process to ensure the color accuracy of these areas.

In some examples, the apparatus may comprise a sensor 403 to acquire spectral reflectance data for the tracked areas of the print job, wherein the printing apparatus is to compare the acquired spectral reflectance data with expected spectral reflectance data for the spot color (e.g. represented by L*a*b color coordinates which may be sent to the emulator 304 along with the spot color layer). In some examples, the sensor 403 may comprise a spectrophotometer, e.g. an inline spectrophotometer located in the printer 306. In some examples, the sensor 403 may be to continuously monitor the spectral reflectance data for the spot color on printed pages of the print job as the job is printed. In some examples, the sensor 403 may be to periodically monitor the spectral reflectance data. In some examples, the printer may be to print an artificial test job, which is then analysed by the sensor 403. In some examples, the artificial test job may include measureable spot color rectangles at given positions on a page so that location dependent variations in the spot color spectral reflectance data can be detected. In some examples, the printer may print a test job before commencing a print job and then monitor reflectance data of spot color areas during printing of the print job.

In some examples, the emulator 304 is to convert the second set of images into the third set of images based on an emulation conversion map. In some examples, the apparatus is to adjust the emulation conversion map based on the comparison between the acquired spectral reflectance data and the expected spectral reflectance data. Using a feedback system in this way can improve the stability and color accuracy of the spot colors as printed, and compensate for fluctuations of the printing process as a function of space and time.

The emulation conversion map can be adjusted to take into account location and or temporal dependent variations in the spot color as printed when converting the spot color layer into process color separations. Therefore, the spot color can be represented more accurately in the print job as printed. Applying the adjustment to the emulation conversion map also means that processing power is concentrated on ensuring the accuracy of the spot colors in particular.

In some examples, where the sensor 403 is to continuously or periodically acquire spectral reflectance data, the apparatus is to iteratively update the emulation conversion map.

Continuously monitoring the spectral reflectance data for the spot colors can enable a real-time color correction to be applied, such that noise of the printing process as a function of position on the print media and time can be digitally compensated in real-time.

In some examples, the printing apparatus 400 comprises a digital front end (DFE) 404 and a press 406. In some examples, the raster image processor is part of the DFE 404 and the emulator is part of the press 406. In some examples, the blender module 402 is also part of the press 406. Image data for the spot colors is passed from the raster image processor to the emulator DFE to the press Therefore, image data representing spot colors is kept separate from image data representing the standard colors, until this data reaches the press.

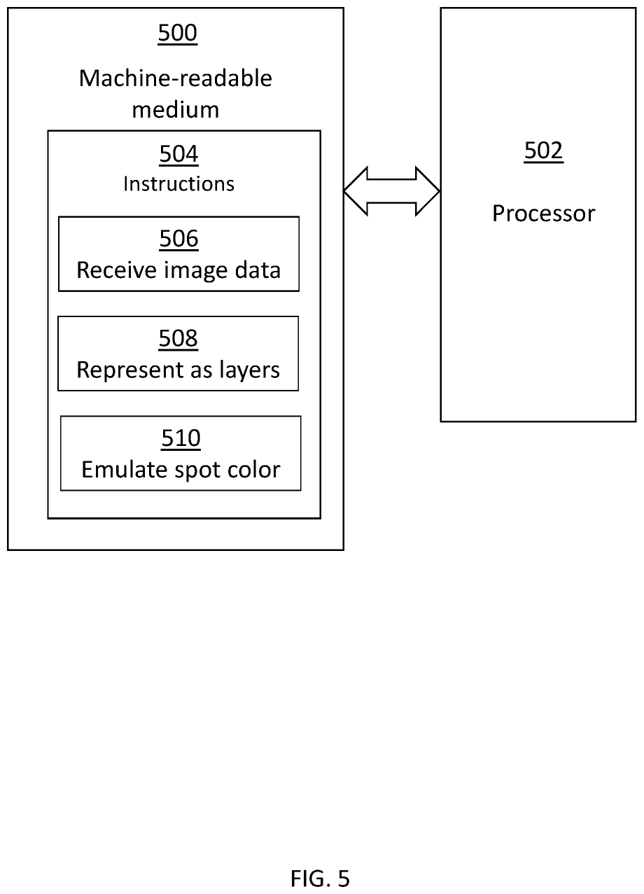

FIG. 5 shows a tangible machine-readable medium 500 in association with a processor 502. In some examples, the machine-readable medium 500 may be to perform part or all of method 100 or method 200. In some examples, the machine-readable medium 500 may be part of a printing apparatus such as printing apparatus 300 or 400.

Machine-readable medium 500 comprises a set of instructions 504 which, when executed by the processor 502 cause the processor 502 to, at block 506, receive image data representing a print job, the print job comprising a first area having a first color which has been pre-defined as a spot color and a second area having a second color which is not pre-defined as a spot color. The instructions 504 also include instructions to, at block 508, represent the image data as a plurality of color layers, wherein the first color is represented as a spot color layer and the second color is converted into a first plurality of color separation layers.

At block 510, the instructions are to emulate the spot color layer by representing the spot color as a second plurality of color separation layers.

In some examples, the machine-readable medium 500 may comprise further instructions to determine at least one print parameter for printing the spot color layer, and apply a correction to the spot color layer based on the print parameter. For example the printing parameter may be a location on a print media, a time, or a measured parameter such as measured spectral reflectance of a spot color area once printed.

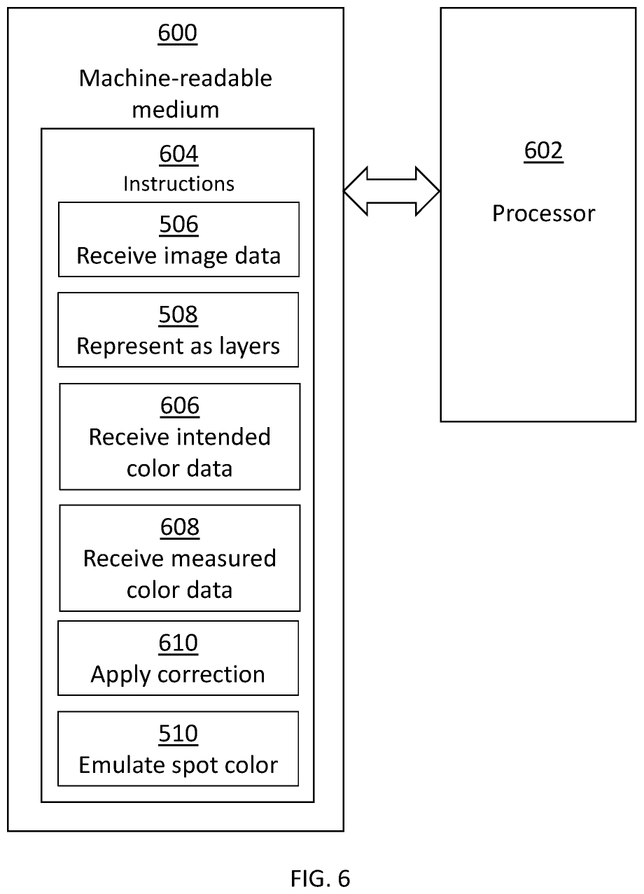

FIG. 6 shows a tangible machine-readable medium 600 in association with a processor 602. In some examples, the machine-readable medium 500 may be to perform part or all of method 100 or method 200. In some examples, the machine-readable medium 500 may be part of a printing apparatus such as printing apparatus 300 or 400. The machine-readable medium 600 includes instructions 604, which include blocks 506, 508 and 510, as described above in relation to FIG. 5.

The machine-readable medium 600 includes further instructions to, at block 606, receive intended color data for the spot color. This may comprise receiving e.g. L*a*b* color values for the spot color, or other suitable data representing color values of the spot color. The instructions further comprise, at block 608, receiving measured color data for the spot color as printed (for example, as printed on a test page or on a previous page of the print job.) e.g. as measured by a sensor from a previous page of the print job. At block 610, the instructions are to apply a correction to the spot color layer based on a comparison between the intended color data and the measured color data.

In some examples, emulating the spot color layer comprises applying an emulation conversion map to the spot color layer to represent the spot color as the second plurality of color separation layers, and applying the correction to the spot color layer comprises applying a correction to the emulation conversion map.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. A method comprising:
receiving, at a raster image processor, image data representing a print job, the image data representing an area to be printed using a process color separation and an area to be printed using a spot color;
producing at the raster image processor, a first rasterized image representing a layer of the print job having the process color and a second rasterized image representing a layer of the print job having the spot color;
receiving at an emulator, the second rasterized image; and
representing, by the emulator, the second rasterized image as a plurality of constituent process color separation layers.

2. A method according to claim 1, further comprising performing a first set of corrections on the first rasterized image and performing a second set of corrections on the plurality of constituent process color separation layers.

3. A method according to claim 1 further comprising combining the plurality of constituent process color separation layers with the first rasterized image.

4. A printing apparatus comprising:
a raster image processor engine to convert an image file representing a print job into a plurality of rasterized images wherein a first set of the plurality of rasterized images each represent a color separation of the printing apparatus and wherein a second set of the rasterized images each represent a spot color to be formed from a plurality of the color separations of the printing apparatus;
an emulator, wherein the emulator is to:
convert each rasterized image of the second set into a third set of rasterized images each representing a color separation of the printing apparatus; and
a printer to print the print job using a set of color separations as defined by the first and third sets of rasterized images.

5. A printing apparatus according to claim 4, further comprising a blender module to combine the first set of rasterized images with the third set of rasterized images to form a fourth set of rasterized images, each representing a color separation of the printing apparatus.

6. A printing apparatus according to claim 5, wherein the blender module is to, for an overlap area of the print job representing an overlap between a spot color and a second color, simulate overprinting between the spot color and the second color to provide simulated color data, and determine intended color data for the overlap area in the fourth set of rasterized images based on the simulated color data.

7. A printing apparatus according to claim 4, further comprising tracking areas of the print job that comprise a spot color, based on the second set of rasterized images.

8. A printing apparatus according to claim 7, further comprising a sensor to acquire spectral reflectance data for the tracked areas of the print job, wherein the printing apparatus is to compare the acquired spectral reflectance data with expected spectral reflectance data for the spot color.

9. A printing apparatus according to claim 8, wherein the emulator is to convert the second set of images into the third set of images based on an emulation conversion map and wherein the apparatus is to adjust the emulation conversion map based on the comparison between the acquired spectral reflectance data and the expected spectral reflectance data.

10. A printing apparatus according to claim 9, wherein the sensor is to continuously monitor spectral reflectance data for the spot color and the apparatus is to iteratively update the emulation conversion map.

11. A printing apparatus according to claim 4, comprising a digital front end (DFE) and a press and wherein the raster image processor is part of the DFE and the emulator is part of the press.

12. A tangible machine-readable medium comprising a set of instructions which, when executed by a processor cause the processor to:
receive image data representing a print job, the print job comprising a first area having a first color which has been pre-defined as a spot color and a second area having a second color which is not pre-defined as a spot color;
represent the image data as a plurality of color layers, wherein the first color is represented as a spot color layer and the second color is converted into a first plurality of color separation layers; and
emulate the spot color layer by representing the spot color as a second plurality of color separation layers.

13. A machine-readable medium according to claim 12, further comprising instructions to:
determine at least one print parameter for printing the spot color layer;
apply a correction to the spot color layer based on the print parameter.

14. A machine-readable medium according to claim 12 further comprising instructions to:
receive intended color data for the spot color;
receive measured color data for the spot color as printed; and
apply a correction to the spot color layer based on a comparison between the intended color data and the measured color data.

15. A machine-readable medium according to claim 14 wherein emulating the spot color layer comprises applying an emulation conversion map to the spot color layer to represent the spot color as the second plurality of color separation layers; and wherein applying the correction to the spot color layer comprises applying a correction to the emulation conversion map.
